(19) United States
(12) Patent Application Publication
(10) Pub. No.: US 2021/0333896 A1
(43) Pub. Date: Oct. 28, 2021

(54) DISPOSABLE STYLUS

(71) Applicant: Desi Rementeria, The Colony, TX (US)

(72) Inventor: Desi Rementeria, The Colony, TX (US)

(21) Appl. No.: 17/135,667

(22) Filed: Dec. 28, 2020

Related U.S. Application Data
(60) Provisional application No. 63/016,296, filed on Apr. 28, 2020.

(51) Int. Cl. G06F 3/0354; G06F 3/039

(52) U.S. Cl. CPC G06F 3/03545; G06F 3/0393

(57) ABSTRACT

A disposable stylus is configured to engage both capacitive touchscreen devices and resistive touchscreen devices. The disposable stylus has a tube further comprising a first end and a second end. A conductive foil is wrapped around an exterior surface the tube from the first end to the second end. A conductive rubber tip covers the first end and a portion of the conductive foil. The conductive rubber tip engages the touchscreen device.

### RELATED APPLICATION

This application claims priority to provisional patent application U.S. Ser. No. 63/016,296 filed on Apr. 28, 2020, the entire contents of which is herein incorporated by reference.

### BACKGROUND

The embodiments herein relate generally to devices used to engage both capacitive touch screens and resistive touch screens.

Prior to embodiments of the disclosed invention, there was no stylus that was disposable and multifunctional. Some other endeavors in this field include U.S. Pat. No. 10,589,564 to Thomas L. Gianfagna, U.S. Pat. No. 5,635,682 to Erik B. Cherdak, and U.S. Pat. No. 8,125,469 to Badaye Massoud, U.S. Patent Publication US20120327045 Peter James Skinner, and German Patent Publication DE 202012104299U1 filed by Merete Man GMBH. Embodiments of the disclosed invention solve these problems.

### SUMMARY

A disposable stylus is configured to engage both capacitive touchscreen devices and resistive touchscreen devices. The disposable stylus has a tube further comprising a first end and a second end. A conductive foil is wrapped around an exterior surface of the tube from the first end to the second end. A conductive rubber tip covers the first end and a portion of the conductive foil. The conductive rubber tip engages the touchscreen device.

In some embodiments, a rubber end cap covers the second end of the tube. The tube is made from paper having a weight of at least 60 grams per square meter (gsm) but no more than 120 gsm; wherein the tube does not collapse upon normal pressure of a human user pushing the conductive rubber tip against the touchscreen device. A film can cover the conductive foil between the first end and the second end.

### BRIEF DESCRIPTION OF THE FIGURES

The detailed description of some embodiments of the invention is made below with reference to the accompanying figures, wherein like numerals represent corresponding parts of the figures.

FIG. 1 shows a perspective view of one embodiment of the present invention shown in use;

FIG. 2 shows a perspective view of one embodiment of the present invention shown;

FIG. 3 shows a section view of one embodiment of the present invention shown taken along line 3-3 in FIG. 2;

FIG. 4 shows an enlarged detail view of one embodiment of the conductive rubber tip of the present invention shown;

FIG. 5 shows an enlarged detail view of one embodiment of the rubber end cap of the present invention shown; and

FIG. 6 shows an enlarged exploded section view of one embodiment of the conductive rubber tip of the present invention shown.

### DETAILED DESCRIPTION OF CERTAIN EMBODIMENTS

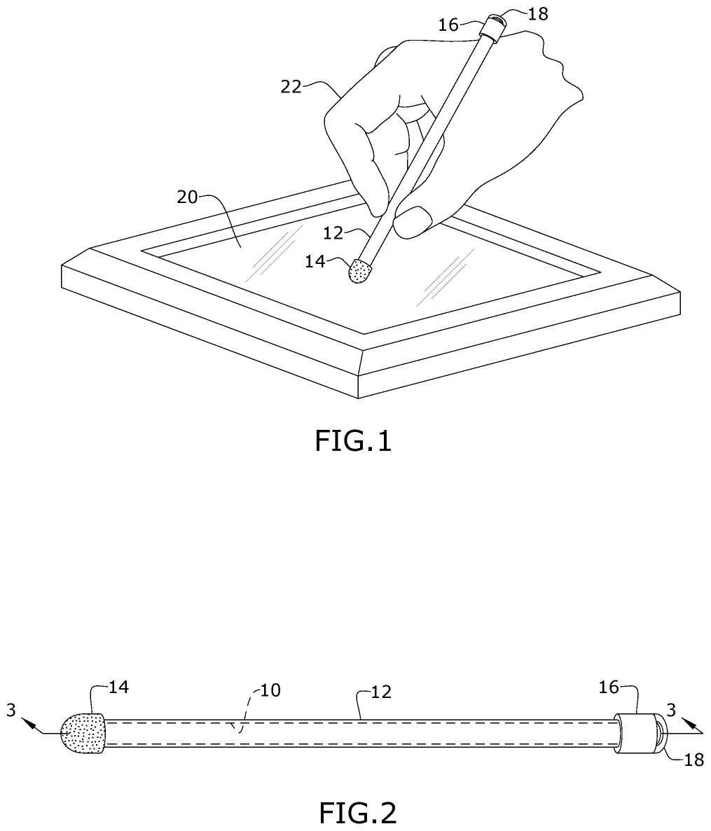

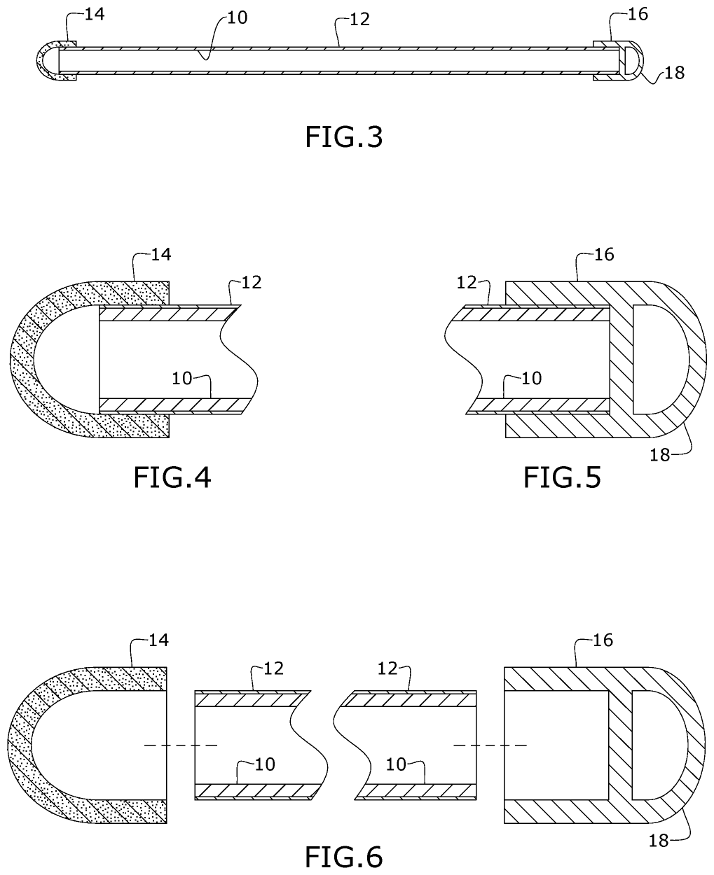

By way of example, and referring to FIGS. 1-6, one embodiment of a disposable stylus comprises a paper tube 10. A conductive foil wrap 12, wraps around the paper tube 10. In some embodiments, a film layer surrounds the conductive foil wrap 12. The paper is at least one, but up to four layers of paper. Each layer of the paper can be 60 gsm to 120 gsm weight paper. The paper should be of a kind that can be easily recycled.

The paper tube 10 has a first end and a second end. The first end is covered with a conductive rubber tip 14. The second end is covered with a rubber end cap 16. The rubber end cap 16 is joined to a loop 18. The rubber end cap is not conductive and will not make an electronic mark on a touch screen 20.

Where a film layer is used, the film layer covers the entire conductive film wrap 12 including beneath the conductive rubber tip 14 and the rubber end cap 16. The film layer prevents the foil wrap from being worn away and increases longevity of the disposable stylus.

To make the invention, glue can be used to bind the conductive rubber tip 14 and the rubber end cap 16 to the conductive foil wrap 12. This makes the conductive rubber tip 14 and the rubber end cap 16 more durably attached to the conductive foil wrap 12. The glue can be conductive glue but conductive glue is not required for operation.

A user 22 can use the disposable stylus against a touch screen 20. When finished the user can dispose of the disposable stylus. Capacitive touchscreens use sensors and technologies to measure the change in the electrostatic field around the screen. The electrostatic field is changed when touched by a finger.

Similar principles apply when using a capacitive stylus. The capacitive stylus conducts an electrical charge from the user's hand to the screen surface. The invention is a disposable stylus. The disposable stylus has a conductive rubber tip 14 over one end of a paper tube where the tube also has a second end. The tube further consists of a conductive material that forms an electrical coupling between the conductive rubber tip 14 and the location upon which a hand of a user 22 will touch when the person is using the stylus in conjunction with a touchscreen device 24.

In some embodiments, a touch screen can be a capacitive touch screen or a resistive touch screen or any other touch screen that can be engaged by a human user.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶6. In particular, any use of “step of” in the claims is not intended to invoke the provision of 35 U.S.C. § 112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A disposable stylus, configured to engage both capacitive touchscreen devices and resistive touchscreen devices; the disposable stylus comprising:
a tube further comprising a first end and a second end;
a conductive foil, wrapped around an exterior surface of the tube from the first end to the second end;
a conductive rubber tip, covering the first end and a portion of the conductive foil, wherein the conductive rubber tip engages the touchscreen device.

2. The disposable stylus of claim 1, further comprising a rubber end cap covering the second end of the tube.

3. The disposable stylus of claim 2, wherein the tube is made from paper having a weight of at least 60 gsm but no more than 120 gsm; wherein the tube does not collapse upon normal pressure of a human user pushing the conductive rubber tip against the capacitive touchscreen device.

4. The disposable stylus of claim 3, a film, covering the conductive foil between the first end and the second end.
